(19) United States
(12) Patent Application Publication
(10) Pub. No.: US 2010/0064005 A1
(43) Pub. Date: Mar. 11, 2010

(54) CONTENT ACQUISITION PROCESSING DEVICE, CONTENT DISTRIBUTION SYSTEM, CONTENT ACQUISITION PROCESSING METHOD, AND ITS PROGRAM

(76) Inventors: Toshiyuki Amaya, Saitama (JP); Kanta Oguro, Saitama (JP); Alain Soquet, Brussels (BE); Mark Wharton, Tokyo (JP)

Correspondence Address: KRATZ, QUINTOS & HANSON, LLP, 1420 K Street, N.W., Suite 400, WASHINGTON, DC, 20005, US

(21) Appl. No.: 12/305,091

(22) PCT Filed: Jun. 16, 2006
(86) PCT No.: PCT/JP2006/312170

§ 371 Date: Jan. 23, 2009

(51) Int. Cl. G06F 13/00

(52) U.S. Cl. 709/204

(57) ABSTRACT

A terminal of an advertisement distribution system acquires, from a controller, subscription metadata respectively defined for each of first to fourth service servers regarding whether or not to distribute advertising content to be subscribed, and specifies, from among the first to fourth service servers, one or more servers that distribute the advertising content to be subscribed as a subscribed service distribution device. The terminal recognizes a difference between the advertising content adapted for distribution by the subscribed service distribution device and the already acquired advertising content, and transmits distribution request information to the subscribed service distribution device to acquire necessary advertising content.

### TECHNICAL FIELD

The present invention relates to a content acquisition processing device, a content distribution system, a content acquisition processing method, and a program thereof, in which a content distributed by a content distribution device based on a request distributing information that requests distribution of a predetermined content is acquired.

### BACKGROUND ART

Conventionally, an arrangement in which a content is acquired via a network is known (see, e.g., Patent Document 1).

According to the arrangement disclosed in Patent Document 1, when it is necessary to download a content as an item as a result of a request by a user, a corresponding meta information is acquired via a network; an item identifier in the meta information is examined; and it is determined whether or not the item identifier coincides with any one of the item identifiers in a meta information saving section. Subsequently, when a coinciding item is found, it is examined which item identifier involves a newer item version. Then, when the item version in the acquired meta information is new, the item version of this item is updated.

Further, necessity of updating is decided for each individual file in the item. When not saved in a file saving section, the file is downloaded and saved with a last updated time. On the other hand, when a file is already saved, necessity of updating is determined based on last updated times. If necessary, the file is downloaded and saved with a last update time.

According to the arrangement, if an item identifier that coincides with the acquired item identifier does not exist in the meta information saving section, the item identifier, the item version, individual files contained in the item, and the last updated time are saved.

Patent Document 1

JP-A-2003-316639

### DISCLOSURE OF THE INVENTION

### Problems to Be Solved by the Invention

There may be a case where a system including the above-described content download device as disclosed in Patent Document 1 and another system lack compatibility with each other system. In this case, a user cannot enjoy a service supplied by another system. Also, a content supplier cannot aim at a large number of users. As a result, business remains small in terms of scale and range.

Unification of specifications may be one way of solving such a problem.

However, if specifications are unified, change of specifications may result in degraded service or lowered competitiveness of the systems, or in additional costs for the change. Unification of specifications is not an easy choice.

Accordingly, a simple arrangement in which a favorable content distributed by a plurality of content distribution devices can be acquired is expected.

An object of the invention is to provide a content acquisition processing device, a content distribution system, a content acquisition processing method, and a program thereof, in which a favorable content distributed by a plurality of content distribution devices can be acquired in a simple arrangement.

### Means for Solving the Problems

A content acquisition processing device according to an aspect of the invention is a content acquisition processing device that acquires a content distributed by a content distribution device based on a content distribution information that requests distribution of a predetermined content, the content acquisition processing device including: a content acquirer that acquires the content; a subscription information acquirer that acquires a subscription information regarding whether or not the content distribution device distributes the content to be subscribed, the subscription information being defined for each content distribution device; a subscribed device specifier that specifies the content distribution device as a subscribed distribution device based on the subscription information having been acquired; a distributed content recognizer that recognizes the content adapted for distribution by the content distribution device having been specified as the subscription-aimed distribution device; a difference recognizer that recognizes a difference between the content adapted for distribution and having been recognized and the content having been acquired in advance; and a distribution requestor that transmits the distribution request information that requests distribution of the content corresponding to the recognized difference to the content distribution device having been specified as the subscribed distribution device.

A content distribution system according to another aspect of the invention includes: a plurality of content distribution devices that distribute a content based on a distribution request information that requests a distribution of a predetermined content; and the content acquisition processing device according to claim 1 or 2, the content acquisition processing device being connected to the plurality of content distribution devices via a network and acquiring the content distributed from the content distribution device via the network based on the distribution request information.

A content acquisition processing method according to still another aspect of the invention is a content acquisition processing method that, by a computer, acquires a content distributed by a content distribution device based on a distribution request information that requests distribution of a predetermined content, in which the computer acquires the content, acquires a subscription information regarding whether or not the content distribution device distributes the content to be subscribed, the subscription information being defined for each content distribution device, specifies the content distribution device as a subscribed distribution device based on the subscription information having been acquired, recognizes the content adapted for distribution by the content distribution device having been specified as the subscribed distribution device, recognizes a difference between the content adapted for distribution and having been recognized and the content having been acquired in advance, and transmits the distribution request information that requests distribution of the content corresponding to the recognized difference to the content distribution device having been specified as the subscribed distribution device.

A content acquisition processing program according to still another aspect of the invention is a content acquisition processing program that instructs a computer to execute the above-described content acquisition processing method.

### BRIEF DESCRIPTION OF DRAWINGS

FIG. 1 is a block diagram showing a schematic arrangement of an advertisement distribution system according to a first embodiment of the invention.

FIG. 2 shows subscription metadata according to the first embodiment and a second embodiment of the invention.

FIG. 3 is a schematic diagram showing how server VAAM data is stored in a first service server (server storage section) according to the first and second embodiments.

FIG. 4 shows CDDL metadata according to the first and second embodiments.

FIG. 5 is a block diagram showing a schematic arrangement of the first, second, and third service servers (server processing section) according to the first and second embodiments.

FIG. 6 is a schematic diagram showing how server stream data is stored in a fourth service server (server storage section) according to the first and second embodiments.

FIG. 7 is a block diagram showing a schematic arrangement of the fourth service server (server processing section) according to the first and second embodiments.

FIG. 8 is a block diagram showing a schematic arrangement of a terminal according to the first and second embodiments.

FIG. 9 is a flowchart showing a distribution process of an advertising content according to the first embodiment.

FIG. 10 is a block diagram showing a schematic arrangement of an advertisement distribution system according to the second embodiment.

FIG. 11 is a block diagram showing a schematic arrangement of a mirror server according to the second embodiment.

FIG. 12 shows subscription metadata edited by the mirror server according to the second embodiment.

FIG. 13 is a flowchart showing a distribution process of an advertising content according to the second embodiment.

FIG. 14 also is the flowchart showing the distribution process of the advertising content according to the second embodiment.

FIG. 15 also is the flowchart showing the distribution process of the advertising content according to the second embodiment.

FIG. 16 is a schematic diagram showing how data is stored in a mirror content storage section according to another embodiment.

### EXPLANATION OF CODES

10, . . . subscription metadata (subscription information)

24, 34 . . . advertising content

100A, 100B . . . advertisement distribution system (content distribution system)

200 . . . network

400A, 600A . . . first service server (content distribution device)

400B, 600B . . . second service server (content distribution device)

400C, 600C . . . third service server (content distribution device)

400D . . . fourth service server (content distribution device)

434A, 434D . . . server download recognizer (also works as end-of-distribution recognizer)

500, 800 . . .terminal (content acquisition processing device)

561 . . . terminal subscription editor (also works as subscription information acquirer)

562, 862 . . . subscribed service distribution device specifier (subscribed device specifier)

563 . . . distributed content recognizer

564 . . . difference recognizer

565 . . . distribution requestor

566 . . . terminal save controller (also works as content acquirer)

567 . . . end notifier

700 . . . mirror server (alternative distribution device)

720 . . . mirror content storage section (content storage)

861 . . . terminal subscription editor (also works as subscription information acquirer and subscription information transmitter)

### BEST MODE FOR CARRYING OUT THE INVENTION

### First Embodiment

A first embodiment of the invention will be described hereinbelow with reference to the drawings.

In the first embodiment and a second embodiment set forth below, a content distribution system of the invention will be exemplarily described in the form of an advertisement distribution system that distributes content for advertising goods, shops, or businesses (hereinafter referred to as advertising content). Incidentally, the distributed content is not limited to advertising content, but may include television programs, movies, and music.

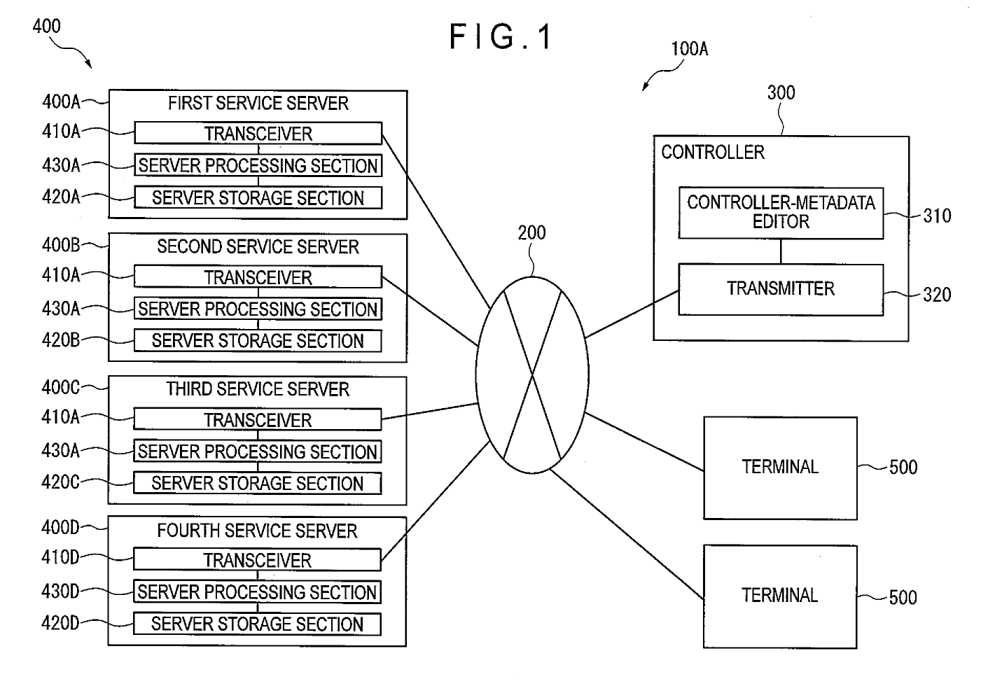

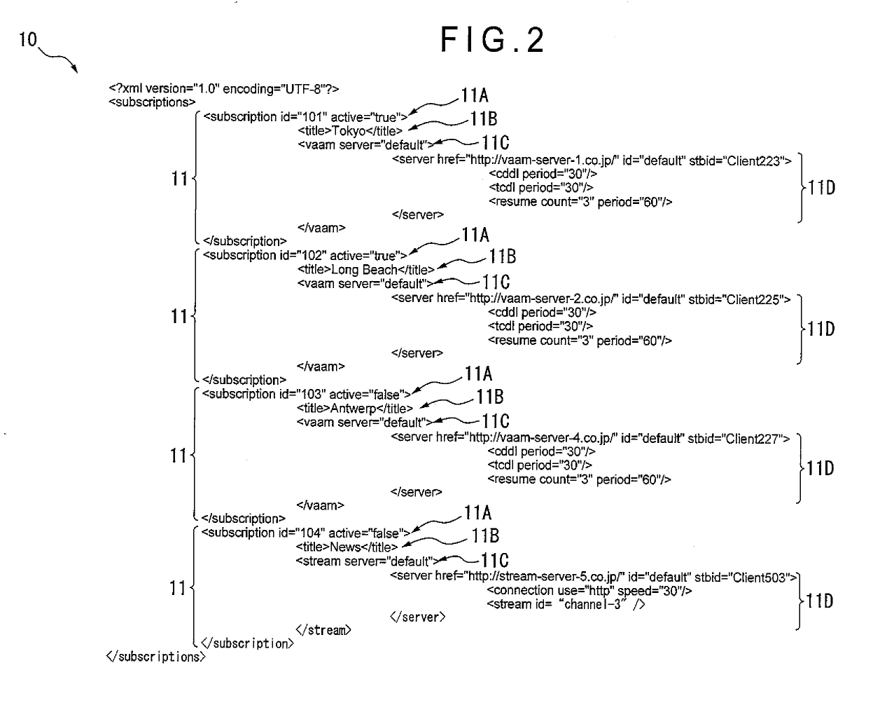

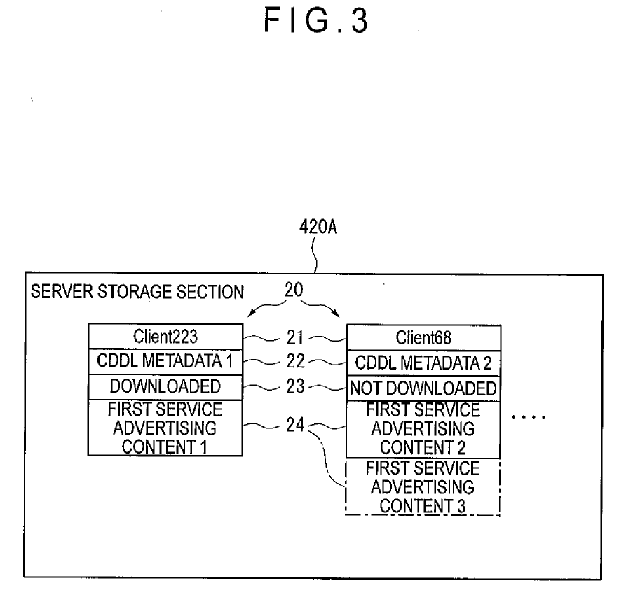

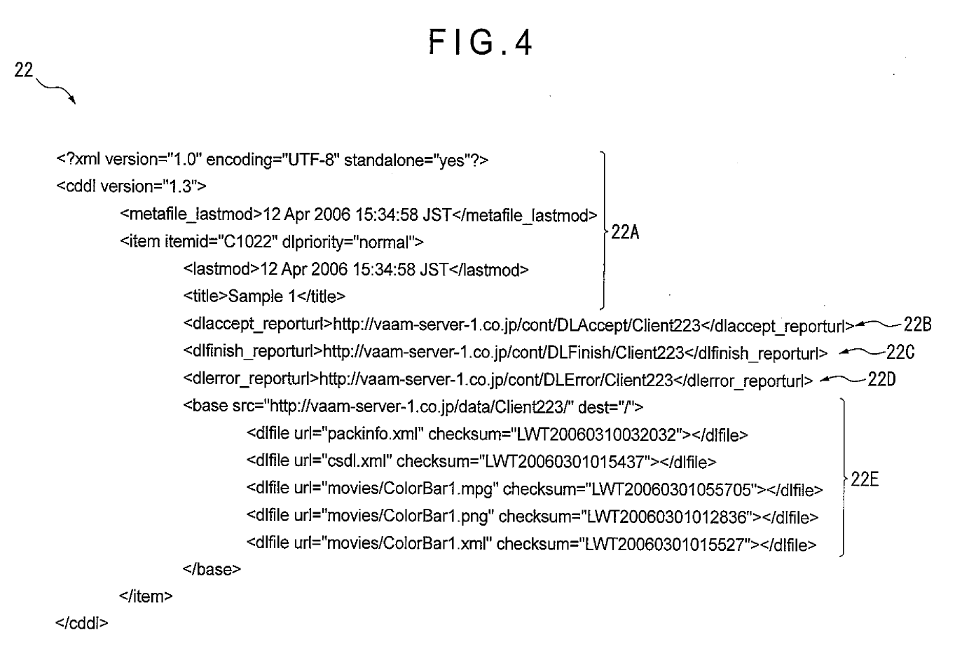

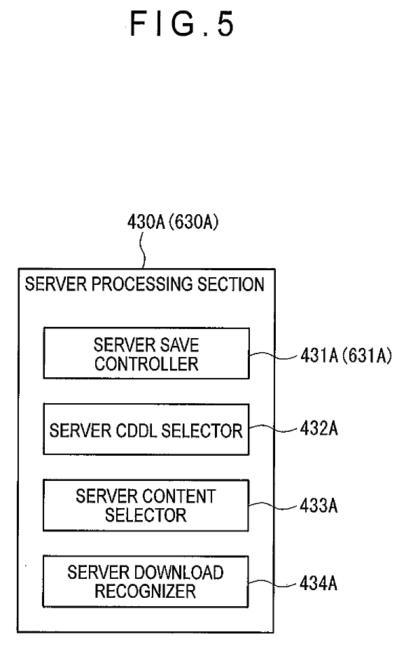

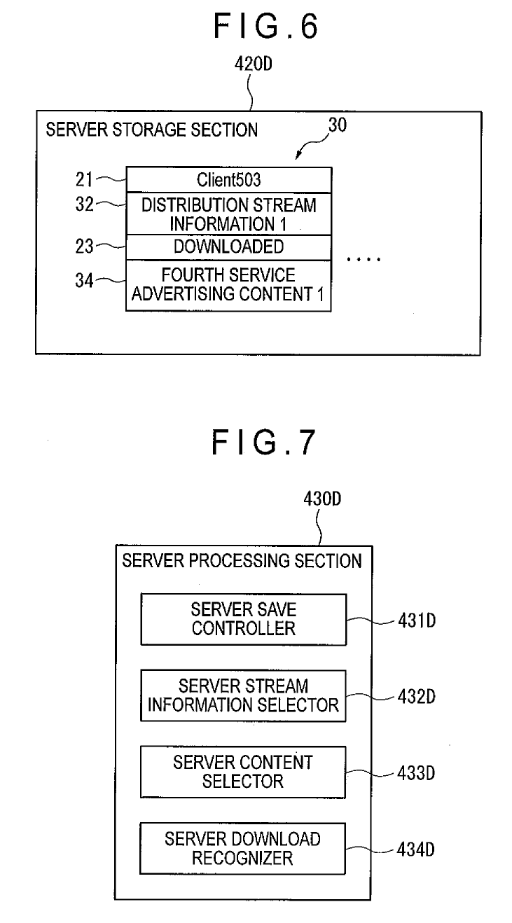

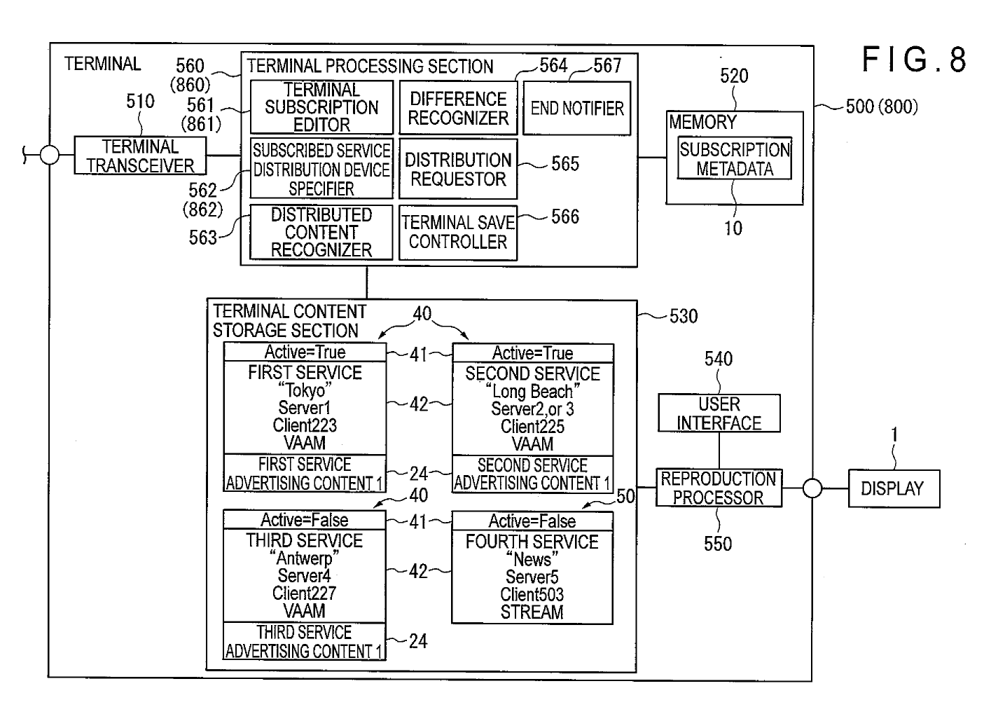

FIG. 1 is a block diagram showing a schematic arrangement of the advertisement distribution system. FIG. 2 shows subscription metadata. FIG. 3 is a schematic diagram showing how server VAAM data is stored in a first service server (server storage section). FIG. 4 shows CDDL metadata. FIG. 5 is a block diagram showing a schematic arrangement of the first, second, and third service servers (server processing section). FIG. 6 is a schematic diagram showing how server stream data is stored in a fourth service server (server storage section). FIG. 7 is a block diagram showing a schematic arrangement of the fourth service server (server processing section). FIG. 8 is a block diagram showing a schematic arrangement of a terminal.

Arrangement of Advertisement Distribution System

In FIG. 1, 100A denotes an advertisement distribution system (content distribution system).

The advertisement distribution system 100A includes a network 200, a controller 300, a service server section 400, and two terminals 500 (content acquisition processing device).

Here, the service server section 400 includes a first service server 400A (content distribution system), a second service server 400B (content distribution system), a third service server 400C (content distribution system), and a fourth service server 400D (content distribution system).

Incidentally, the number of the servers that form the service server section 400 is not limited to four, but may be any suitable number more than one. Also, although an arrangement having two terminals 500 will be exemplarily described, an arrangement having one terminal 500 or three or more terminals 500 may be employed.

The controller 300, the service server section 400, and the terminals 500 are connected to the network 200. Examples of the network 200 include: the Internet; an intranet; a LAN (local area network); a network such as a communication line network or a broadcasting network where a plurality of base stations capable of communicating information via wireless media; and wire media itself or wireless media itself, the wire media or wireless media being capable of directly communicating information between the controller 300, the service server section 400, and the terminals 500.

The controller 300 includes a controller-metadata editor 310 and a transmitter 320.

Based on settings inputted via an inputting unit (not shown), the controller-metadata editor 310 creates or edits subscription metadata 10 (subscription information) as shown in FIG. 2.

Here, an arrangement of the subscription metadata 10 will be described.

The subscription metadata 10 is data for setting for each terminal 500 to acquire advertising content 24, 34 (see, FIGS. 3 and 6) suitably from a different one of the first to fourth service servers 400A to 400D. The subscription metadata 10 includes the same number of subscription informations 11 as the number of servers forming the service server section 400. The number is four in the embodiment.

In the following description, the four subscription informations 11 will be referred to as, in a descending order as shown in FIG. 2, a first service subscription information 11, a second service subscription information 11, a third subscription information 11, and a fourth subscription information 11. Also hereinbelow, the first service subscription information 11 will be mainly exemplified.

The first service subscription information 11 includes a record of whether or not the advertising content 24 of the first service server 400A should be acquired.

The first service subscription information 11 includes: an object-defining information 11A that defines whether or not the advertising content 24 of the first service server 400A is to be subscribed; a title information 11B that shows a title of a service to which the advertising content 24 belongs; a distributor's attribute information 11C that shows an attribute of a distributor of the advertising content 24; a communication-related information 11D that shows a URL (universal resource locater) of the distributor, IDs of the terminals 500, or the like.

More specifically, the object-defining information 11A indicates that the advertising content 24 is to be subscribed when “active=true” is recorded, and indicates that the advertising content 24 is not to be subscribed when “active=false” is recorded.

In addition, “vaam server=‘default’” of the distributor's attribute information 11C indicates that the distributor is adapted for communication in the VAAM (virtual appliance access method plus) protocol as the communication protocol and that the ID of the distributor is defaulted.

The URL of the distributor is shown after “server href=” of the communication-related information 11D, the ID of the distributor is shown after “id=”, and the ID of the terminal 500D that corresponds to the distributor is shown after “stbid=”.

In the distributor's attribute information 11C which belongs to subscription information 11 of the fourth service, “stream server=‘default”’ indicates that the distributor is adapted for communication in the stream protocol as the communication protocol and that such setting is defaulted.

In other words, the communication-related information 11D of the first to fourth service subscription informations 11 as shown in FIG. 2 includes a record that the first to fourth service servers 400A to 400D are set as default distributors.

Incidentally, the controller-metadata editor 310 creates and edits the subscription metadata 10 indicating that an advertising content distributed under one protocol is to be subscribed and an advertising content distributed under other protocols is not subscribed. For instance, as shown in FIG. 2, the subscription metadata 10 indicating that the advertising content 24 in the VAAM protocol is to be subscribed but the advertising content 34 in the stream protocol is not to be subscribed.

The transmitter 320 is connected to the network 200, and transmits the subscription metadata 10 to the corresponding terminal 500. Specifically, the transmitter 320 transmits the subscription metadata 10 to the terminal 500 whose ID is indicated by the communication-related information 11D.

As shown in FIG. 1, the first to third service servers 400A to 400C include transceivers 410A, 410A, and 410A, and server storage sections 420A, 420B, and 420C, and server processing sections 430A, 430A, and 430A.

The transceiver 410A is connected to the network 200, and transmits an information to and receives an information from the predetermined terminal 500 based on the VAAM protocol. Specifically, the transceiver 410A receives informations transmitted from the terminal 500 and suitably outputs the informations to the server processing section 430A, and suitably transmits informations acquired from the server processing section 430A to the predetermined terminal 500.

As shown in FIG. 3, the server storage section 420A stores at least one server VAAM data 20 for distributing the advertising content 24 to the predetermined terminal 500. Although not illustrated herein, the server storage sections 420B and 420C also store the server VAAM data 20.

The server VAAM data 20 is formed by associating: a terminal ID information 21 in which the ID of the terminal 500 is recorded; CDDL (contents download description language) metadata 22; a download status information 23; and at least one advertising content 24. Incidentally, although an arrangement in which the CDDL metadata 22 and the advertising content 24 are associated to form the server VAAM data 20 is exemplarily described herein, an arrangement in which the CDDL metadata 22 or the advertising content 24 are separately managed in a table or the like may also be employed.

The CDDL metadata 22 includes what is needed to conduct communication based on the VAAM protocol.

Specifically, as shown in FIG. 4, the CDDL metadata 22 includes: a header information 22A; a receipt-notifying-address information 22B that shows a URL to be notified to when the CDDL metadata 22 is received; a download-notifying-address information 22C that shows a URL to be notified when download is completed; an error-notifying-address information 22D that shows a URL to be notified when a download error occurs; a content-saving information 22E that shows a URL where the advertising content 24 is saved and a check sum.

As shown in FIG. 5, the server processing section 430A includes, in the form of programs: a server save controller 431A; a server CDDL selector 432A; a server content selector 433A; and a server download recognizer 434A.

The server save controller 431A suitably acquires the server VAAM data 20 created by an advertiser or the like with a content creating device (not shown) or the like. Then, a process in which this server VAAM data 20 is stored in the server storage section 420A, i.e., a saving process, is conducted. Also, when settings inputted via an inputting unit (not shown) indicating that the server VAAM data 20 is updated is recognized, the server VAAM data 20 is updated.

When the server CDDL selector 432A acquires a VAAM protocol starting information from the predetermined terminal 500 via the network 200, the ID of the terminal 500 recorded in this VAAM protocol starting information is recognized. Further, the server VAAM data 20 having a terminal ID information 21 in which the recognized ID is recorded is searched, and the CDDL metadata 22 of the searched server VAAM data 20 is selected. Then, via the network 200, this selected CDDL metadata 22 is transmitted to the terminal 500 that has transmitted the VAAM protocol starting information.

When having acquired a distribution request information from the predetermined terminal 500, the server content selector 433A searches the server VAAM data 20 that corresponds to the terminal 500 based on the ID of the terminal 500 recorded in the distribution request information and the terminal ID information 21. The server content selector 433A also recognizes a URL of the advertising content 24 recorded in the distribution request information. Then, the server content selector 433A acquires the advertising content 24 of the recognized URL from the server VAAM data searched based on the ID of the terminal 500, and distributes the advertising content 24 via the network 200 to the terminal 500 from which the distribution request information has been transmitted.

When having acquired the download finish information from the predetermined terminal 500, the server download recognizer 434A searches the server VAAM data 20 that corresponds to the terminal 500 based on the ID of the terminal 500 recorded in the download finish information and the terminal ID information 21. Then, the server download recognizer 434A records in a download status information 23 of the searched server VAAM data 20 that all the advertising contents 24 have been downloaded.

As shown in FIG. 1, the fourth service server 400D includes a transceiver 410D, a server storage sections 420D, and a server processing section 430D.

The transceiver 410D transmits an information to and receives an information from the predetermined terminal 500 based on the stream protocol.

As shown in FIG. 6, the server storage section 420D stores at least one server stream data 30 for distributing the advertising content 34 to the predetermined terminal 500.

The server stream data 30 is formed by associating: the terminal ID information 21; a distribution stream information 32; a download status information 23; and at least one advertising content 34.

Similarly to the CDDL metadata 22, the distribution stream information 32, though not shown, includes: a receipt-notifying-address information; a download-notifying-address information; an error-notifying-address information; and a content-saving information.

The advertising content 34 is data in the stream format.

As shown in FIG. 7, the server processing section 430D includes, in the form of programs: a server save controller 431D; a server stream information selector 432D; a server content selector 433D; and a server download recognizer 434D.

The server save controller 431D suitably acquires the server stream data 30 from the content creating device or the like to save in the sever storage section 420D. Also, the server save controller 431D suitably updates the server stream data 30 based on inputted settings.

When having acquired the stream protocol starting information from the predetermined terminal 500, the server stream information selector 432D searches the server stream data 30 that corresponds to the ID of the terminal 500 recorded in this stream protocol starting information. Then, the server stream information selector 432D selects a distribution stream information 32 of the searched server stream data 30 and transmits the distribution stream information 32 to the terminal 500 that has transmitted the stream protocol starting information.

Similarly to the server content selector 433A, the server content selector 433D selects the advertising content 34 based on the distribution request information to distribute to the terminal 500.

Similarly to the server download recognizer 434A, the server download recognizer 434D records in the download status information 23 that the advertising content 34 has been downloaded based on the download finish information.

Based on the subscription metadata 10 from the controller 300, the terminal 500 suitably acquires the advertising content 24, 34 from the service server section 400 for reproduction. Here, as shown in FIG. 8, the terminal 500 includes: a terminal transceiver 510; a memory 520; a terminal content storage section 530; a user interface 540; a reproduction processor 550; and a terminal processing section 560.

The terminal transceiver 510, which is connected to the network 200 in a manner switchable between a connected state and a disconnected state, conducts transmittance of informations to and receipt of informations from the controller 300 and the service server section 400 based on the VAAM protocol or the stream protocol. Specifically, the terminal transceiver 510 receives informations from the controller 300 and the service server section 400 and suitably outputs the informations to the terminal processing section 560, and suitably transmits the informations, which have come from the terminal processing section 560, to the controller 300 and the service server section 400.

The memory 520 suitably readably stores the subscription metadata 10. The subscription metadata 10 stored in the memory 520 is suitably edited in the terminal processing section 560.

The terminal content storage section 530 stores the terminal VAAM data 40 and the terminal stream data 50.

The terminal VAAM data 40 is data regarding the advertising content 24 acquired from the service server section 400 based on the VAAM protocol, in other words, data regarding the advertising content 24 acquired from the first to third service servers 400A to 400C, and is updated by the terminal processing section 560. The terminal VAAM data 40 includes: an active information 41; a terminal communication-related information 42; and the advertising content 24.

Similarly to the object-defining information 11A of the subscription metadata 10, the active information 41 indicates that the advertising content 24 is to be subscribed when “active=true” is recorded, and indicates that the advertising content 24 is not to be subscribed when “active=false” is recorded.

An information regarding communication at the time of acquisition of the advertising content 24 is recorded in the terminal communication-related information 42. Specifically, records in the terminal communication-related information 42 include: a service number such as “service 1”; a title of the service such as “Tokyo” that corresponds to the title information 11B; a name of the server and an ID of the terminal 500, such as “Server 1” and “Client 223”, that correspond to the communication-related information 11D; and the protocol at the time of communication such as “VAAM”.

The terminal stream data 50 is data regarding the advertising content 34 acquired from the service server section 400 based on the stream protocol, in other words, data regarding the advertising content 34 acquired from the fourth service server 400D, and is suitably updated by the terminal processing section 560. The terminal stream data 50 includes: the active information 41; and the terminal communication-related information 42.

The terminal content storage section 530 includes a receiving buffer (not shown) for temporarily storing the advertising content 34 distributed based on the stream protocol. The receiving buffer is associated with the terminal stream data 50, and temporarily stores the advertising content 34 that corresponds to the terminal communication-related information 42.

The user interface 540 is connected to the inputting unit (not shown) having a manipulation button or the like. The user interface 540 suitably outputs to a reproduction processor 550 a manipulation signal that corresponds to what is inputted and set with the inputting unit. Examples of such a manipulation signal include a manipulation signal that indicates reproduction of a predetermined advertising content 24, 34.

The reproduction processor 550 is connected to a display 1. Based on a manipulation signal from the user interface 540, the reproduction processor 550 suitably reproduces the advertising content 24 stored in the terminal content storage section 530 and the advertising content 34 stored in the receiving buffer to display on the display 1.

The terminal processing section 560 includes, in the form of programs: a terminal subscription editor 561 (which also works as a subscription information acquirer); a subscribed service distribution device specifier 562 (to-be-subscribed device specifier); a distributed content recognizer 563; a difference recognizer 564; a distribution requestor 565; a terminal save controller 566 (which also works as a content acquirer); and an end notifier 567.

Via the network 200, the controller 300 transmits to the terminal 500 a command that changes what is in the subscription metadata 10. Specifically, the controller 300 transmits a command for addition or deletion of the subscription information written in the subscription metadata 10 or for change of the active information 41, and the terminal 500 that receives the command edits the subscription metadata 10 belonging to this terminal 500 itself according to the instruction of the command.

Alternatively, when having acquired the subscription metadata 10 from the controller 300 via the network 200, the terminal subscription editor 561 may recognize a difference between this subscription metadata 10 and the subscription metadata 10 of the memory 520 to edit the subscription metadata 10 of the memory 520 to become the same as the subscription metadata 10 from the controller 300 based on the recognized difference,

Incidentally, when a new subscription information 11 is added, in other words, when an advertising content of a new service server becomes a to-be-subscribed content, the terminal subscription editor 561 creates an active information 41 and a terminal communication-related information 42 that correspond to this advertising content.

When the advertising content is distributed in the VAAM protocol, these active information 41 and terminal communication-related information 42 are associated with the advertising content 24 by the terminal save controller 566, and saved in the terminal content storage section 530 as the terminal VAAM data 40. On the other hand, when the advertising content 34 is distributed in the stream protocol, the active information 41 and the terminal communication-related information 42 are associated with the receiving buffer to be saved as the terminal stream data 50.

Based on the subscription metadata 10, the subscribed service distribution device specifier 562 specifies from among the first to fourth service servers 400A to 400D a server that distributes the advertising content 24, 34 (subscribed content) as a subscribed service distribution device (subscribed distribution device).

Specifically, the subscribed service distribution device specifier 562 searches subscription information 11 whose object-defining information 11A includes a record that this subscription information 11 involves the to-be-subscribed object. Then, based on the distributor's attribute information 11C of this searched subscription information 11, the subscribed service distribution device specifier 562 specifies from among the first to fourth service servers 400A to 400D a server defaulted as a distributor as the subscribed service distribution device. For instance, based on the subscription metadata 10 as shown in FIG. 2, the subscribed service distribution device specifier 562 specifies the first and second service servers 400A and 400B as the subscribed service distribution devices.

When the subscribed service distribution device is specified in the subscribed service distribution device specifier 562, the distributed content recognizer 563 determines whether or not the subscribed service distribution device corresponds to the VAAM protocol. Then, when having determined that the subscribed service distribution device corresponds to the VAAM protocol, the subscribed service distribution device specifier 562 transmits a VAAM protocol starting information in which the ID of the terminal 500 that corresponds to the subscribed service distribution device to the subscribed service distribution device of the URL recorded in the communication-related information 11D. Further, the subscribed service distribution device specifier 562 acquires a CDDL metadata 22 returned in response to the VAAM protocol starting information and recognizes, based on the content-saving information 22E, the advertising content 24 adapted for distribution.

On the other hand, when having determined that the subscribed service distribution device corresponds to the stream protocol, the distributed content recognizer 563 transmits the stream protocol starting information to the subscribed service distribution device. Then, based on the distribution stream information 32 returned in response to the stream protocol starting information, the distributed content recognizer 563 recognizes the advertising content 34 adapted for distribution.

For instance, when the first and second service servers 400A and 400B are specified as the subscribed service distribution devices, the distributed content recognizer 563 transmits the VAAM protocol starting information based on the URL recorded in the communication-related information 11D of the first and second services, and recognizes, based on the returned CDDL metadata 22, the advertising content 24 adapted for distribution.

When the distributed content recognizer 563 recognizes the advertising content 24, 34 adapted for distribution by the subscribed service distribution device, the difference recognizer 564 recognizes a difference between this recognized advertising content 24, 34 and the already acquired advertising content 24, 34.

Specifically, the difference recognizer 564 determines whether or not the advertising content 24, 34 adapted for distribution by the subscribed service distribution device is stored in the terminal content storage section 530. Then, the difference recognizer 564 suitably outputs a difference information regarding this determination result to the distribution requestor 565.

When the distribution requestor 565 acquires the difference information from the difference recognizer 564 and recognizes that the advertising content 24, 34 not stored in the terminal content storage section 530 exists, the distribution requestor 565 determines that acquisition of this advertising content 24, 34 is necessary. Then, the distribution requestor 565 transmits to the subscribed service distribution device a distribution request information in which the URL of the advertising content 24, 34 to be acquired and the ID of the terminal 500 corresponding to the subscribed service distribution device are recorded.

The terminal save controller 566 acquires the advertising content 24 distributed from the subscribed service distribution device in response to the distribution request information. Then, a process for storing this acquired advertising content 24 in the terminal content storage section 530 as a portion of the terminal VAAM data 40, i.e., a process for saving the advertising content 24 is conducted. In addition, when having acquired the advertising content 34 from the subscribed service distribution device, the terminal save controller 566 temporarily stores this acquired advertising content 34 in a corresponding receiving buffer to suitably adapt this acquired advertising content 34 for reproduction by the reproduction processor 550.

When having recognized that saving of the advertising content 24 has ended by the terminal save controller 566, the end notifier 567 transmits to the subscribed service distribution device the download finish information in which the ID of the terminal 500 that corresponds to the subscribed service distribution device. In addition, when the end notifier 567 receives all the advertising contents 34 and recognizes that reproduction has ended, the end notifier 567 transmits the download finish information to the subscribed service distribution device.

Operation of Advertisement Distribution System

Next, as an example of operation of the advertisement distribution system 100A, a distribution process of an advertising content will be described with reference to the drawings.

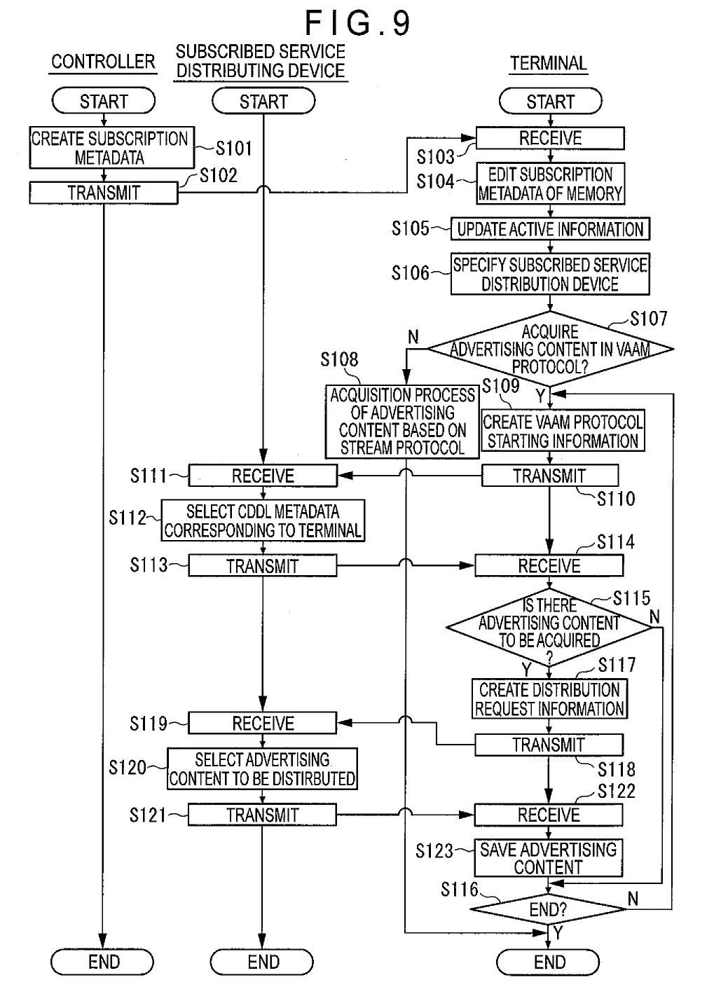

FIG. 9 is a flowchart showing a distribution process of an advertising content.

Initially, as shown in FIG. 9, based on an inputting manipulation by a user, the controller 300 creates subscription metadata 10 that corresponds to a predetermined terminal 500 (Step S101), and subsequently transmits this subscription metadata 10 to the terminal 500 (Step S102).

When having received the subscription metadata 10 (Step S103), the terminal 500 edits the subscription metadata 10 of the memory 520 based on this received subscription metadata 10 (Step S104). Subsequently, the terminal 500 updates an active information 41 of the terminal VAAM data 40 or the terminal stream data 50 (Step S105) and specifies a subscribed service distribution device based on the subscription metadata 10 (Step S106). Then, the terminal 500 determines whether or not to acquire the advertising content 24 from this subscribed service distribution device in the VAAM protocol (Step S107).

In this Step S107, when the terminal 500 determines to acquire the advertising content 34 not in the VAAM protocol but in the stream protocol, i.e., when the fourth service server 400D is specified as the subscribed service distribution device, the terminal 500 suitably conducts, though not described in detail herein, the acquiring process of the advertising content 34 based on the stream protocol (Step S108) and ends the process. On the other hand, when the terminal 500 determines to acquire the advertising content 24 in the VAAM protocol in Step S107, i.e., when any one of the first to third service servers 400A to 400C is specified as the subscribed service distribution device, the VAAM protocol starting information is created (Step S109) and transmits this information to the subscribed service distribution device (Step S110).

When having received the VAAM protocol starting information from the terminal 500 (Step S111), the subscribed service distribution device selects the CDDL metadata 22 that corresponds to the terminal 500 (Step S112). Then, the subscribed service distribution device transmits this CDDL metadata 22 to the terminal 500 specified by the VAAM protocol starting information (Step S113).

When having received the CDDL metadata 22 (Step S114), based on this CDDL metadata 22, the terminal 500 recognizes the advertising content 24 adapted for distribution by the subscribed service distribution device and determines whether or not the advertising content 24 to be acquired exists (Step S115).

In Step S115, when the terminal 500 determines that the advertising content 24 is not to be acquired, the terminal 500 determines whether or not to end the process (Step S116). When having determined to end the process in Step S116, the terminal 500 ends the process. On the other hand, when having determined not to end the process in Step S116, the terminal 500 conducts the process of Step S109.

When having determined that the advertising content 24 is to be acquired in Step S115, the terminal 500 creates the distribution request information of this advertising content 24 (Step S117) and transmits the distribution request information to the subscribed service distribution device (Step S118).

When having received the distribution request information (Step S119), the subscribed service distribution device selects, based on this distribution request information, the advertising content 24 to be distributed to the terminal 500 (Step S120). Then, the subscribed service distribution device transmits this selected advertising content 24 to the terminal 500 specified by the distribution request information (Step S121).

When having received the advertising content 24 (Step S122), the terminal 500 saves this received advertising content 24 in the terminal content storage section 530 as a portion of the terminal VAAM data 40 (Step S123). Subsequently, the terminal 500 transmits the download finish information to the subscribed service distribution device and conducts the process of Step S116.

### Advantages of First Embodiment

As described above, in the first embodiment, the terminal 500 acquires, from the controller 300, the subscription metadata 10 respectively defined for each of the first to fourth service servers 400A to 400D regarding whether or not to distribute the advertising content 24, 34 to be subscribed. Then, a server that distributes the advertising content 24, 34 to be subscribed is specified from among the first to fourth service servers 400A to 400D as the subscribed service distribution device. Subsequently, the terminal 500 recognizes the advertising content 24, 34 adapted for distribution by the subscribed service distribution device and recognizes a difference thereof with regards to the already acquired advertising content 24, 34. Then, the terminal 500 transmits the distribution request information requesting the advertising content 24, 34 to be acquired to the subscribed service distribution device, and acquires the advertising content 24, 34.

With this arrangement, the terminal 500 can acquire the advertising content 24, 34 from at least one of the first to fourth service servers 400A to 400D based on the subscription metadata 10. In other words, service given to the terminal 500 can be easily switched by using the subscription metadata 10.

Accordingly, unification of specifications of the first to fourth service servers 400A to 400D is not necessary, so that lowering of the service and competitiveness of the first to fourth service servers 400A to 400D can be restrained, and occurrence of new cost can be restrained.

Thus, the terminal 500 can acquire a favorable advertising content with a simple arrangement.

In addition, in the subscription metadata 10, a record indicating that the advertising content distributed in one protocol is subscribed but advertising contents distributed in other protocols are not subscribed is arranged. For instance, as shown in FIG. 2, a record indicating that, when the advertising content 24 distributed in the VAAM protocol from the first and second service servers 400A and 400B is subscribed, the advertising content 34 distributed in the stream protocol from the fourth service server 400D is not subscribed is arranged.

Accordingly, the terminal 500 can conduct an acquisition process of the advertising content according to only one protocol and based on the subscription metadata 10 acquired from the controller 300. On the other hand, based on the subscription metadata 10, when the advertising content is arranged to be adapted for acquisition based on a plurality of protocols, the protocols may contradict with each other to prevent appropriate acquisition of the advertising content. For instance, when an acquisition process in the VAAM protocol in the polling scheme is conducted during the acquisition process in the stream protocol, the advertising content 34 in the stream format may be interrupted.

Thus, the terminal 500 can appropriately acquire the advertising content 24, 34.

Further, the advertisement distribution system 100A is formed by: the first to fourth service servers 400A to 400D for distributing the advertising content 24, 34 based on the distribution request information; the terminal 500; and the like.

Thus, the favorable advertising content 24, 34 can be distributed and acquired in a simple arrangement according to the advertisement distribution system 100A.

### Second Embodiment

Next, a second embodiment of the invention will be described with reference to the drawings.

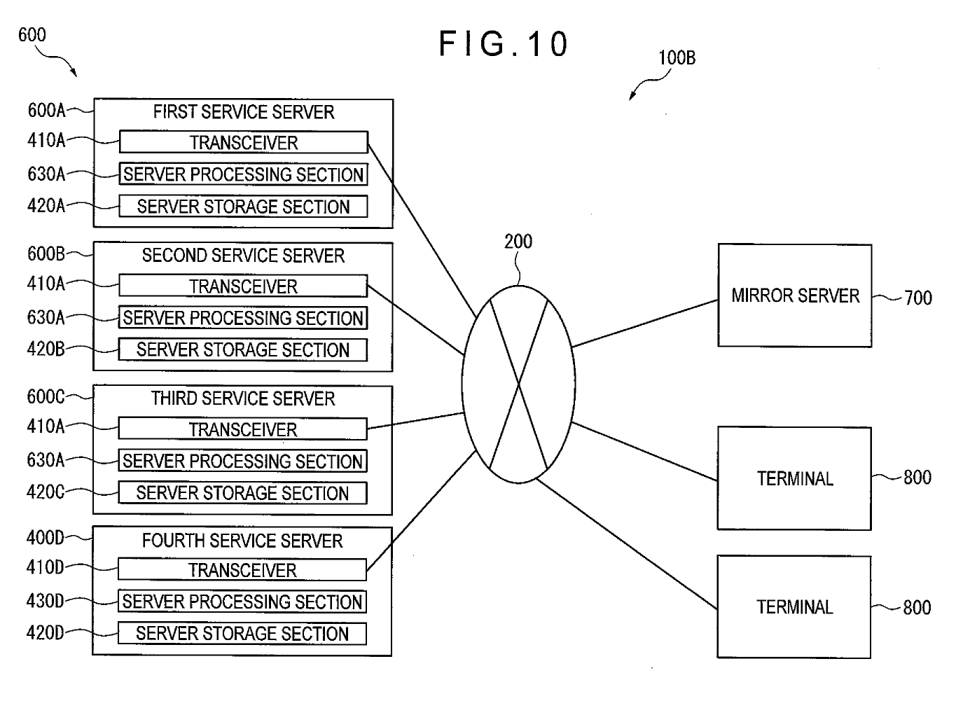

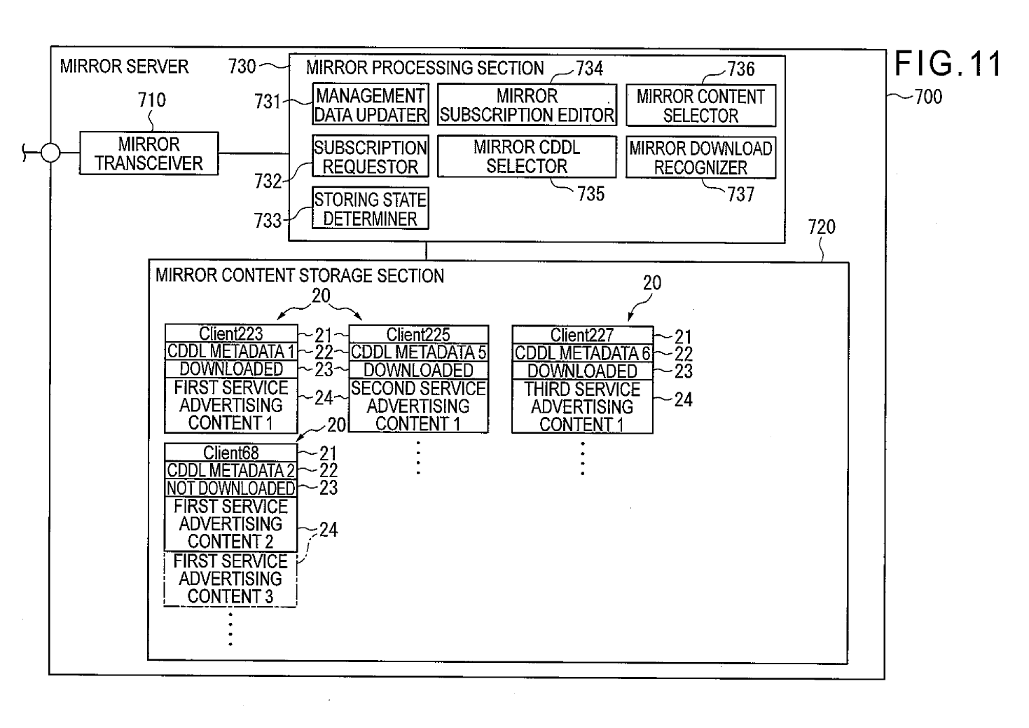

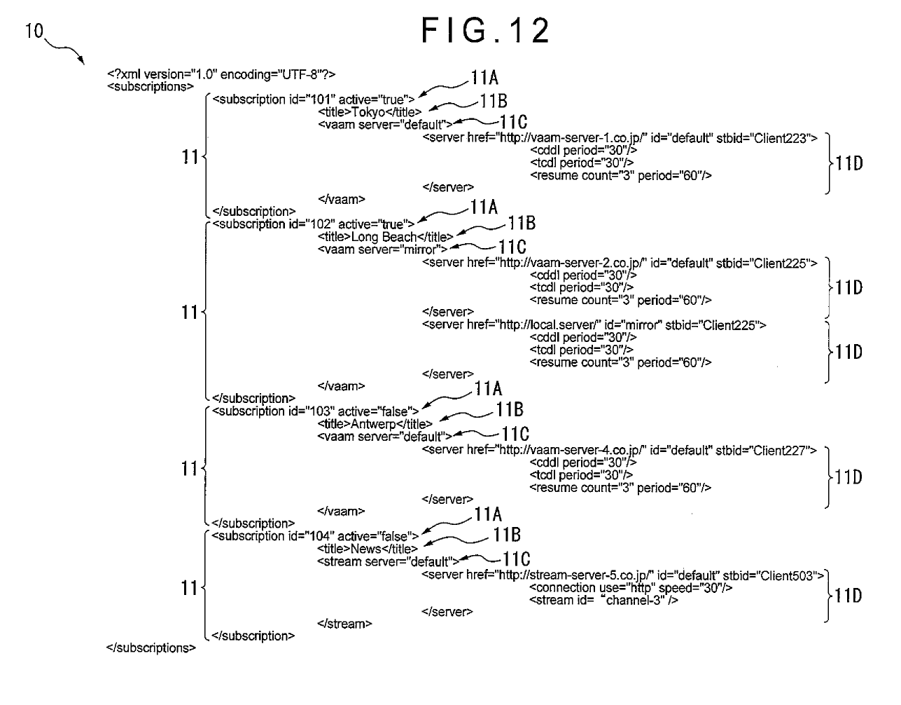

FIG. 10 is a block diagram showing a schematic arrangement of the advertisement distribution system. FIG. 11 is a block diagram showing a schematic arrangement of a mirror server. FIG. 12 shows subscription metadata edited by the mirror server.

Arrangement of Advertisement Distribution System

In FIG. 10, 100B denotes an advertisement distribution system (content distribution system).

The advertisement distribution system 100B includes a network 200, a service server section 600, a mirror server 700 (alternative distribution device), and a terminal 800 (content acquisition processing device). Incidentally, because the service server section 600 and the terminal 800 have arrangements respectively similar to the service server section 400 and the terminal 500 of the first embodiment, the difference thereof will be mainly described.

The service server section 600 includes a first service server 600A (content distribution device), a second service server 600B (content distribution device), a third service server 600C (content distribution device), and a fourth service server 400D (content distribution device). In addition, as shown in FIGS. 5 and 10, the first to third service servers 600A to 600C are arranged to differ from the first embodiment only in a server save controller 631A of the server processing section 630A.

When the server save controller 631A newly saves the server VAAM data 20 and recognizes that the server save controller 631A is connected to the mirror server 700 via the network 200, the server save controller 631A transmits these newly saved server VAAM data 20 to the mirror server 700. In addition, when having updated the server VAAM data 20 based on the inputted settings, the server save controller 631 A transmits this data to the mirror server 700.

Incidentally, for instance, an arrangement in which the server VAAM data 20 is not transmitted but only the new CDDL metadata 22 and the advertising content 24 are transmitted may be employed.

In addition, server download recognizers 434A and 434D of the second embodiment work as the end-of-distribution recognizer of the invention. Specifically, the server download recognizers 434A and 434D acquire the download finish information transmitted from the terminal 800 and the mirror server 700 and update the download status information 23.

Via the network 200, the mirror server 700 is connected to the first to third service servers 600A to 600C and to the terminal 800 in a manner switchable between a connected state and a disconnected state. As shown in FIG. 11, the mirror server 700 includes a mirror transceiver 710, a mirror content storage section 720 (content storage), and a mirror processing section 730.

The mirror transceiver 710, which is connected to the network 200 in a manner switchable between a connected state and a disconnected state, transmits informations to and receives informations from the service server section 600 and the terminal 800 based on the VAAM protocol.

Specifically, the mirror transceiver 710 receives informations from the service server section 600 and the terminal 800 to suitably output the informations to the mirror processing section 730, and suitably transmits the informations from the mirror processing section 730 to the service server section 600 and the terminal 800.

The mirror content storage section 720 stores the server VAAM data 20. This server VAAM data 20 is the same as the data stored in the first to third service servers 600A to 600C, and is suitably updated under control of the mirror processing section 730.

Since this server VAAM data 20 is stored in the mirror content storage section 720, the mirror server 700 can distribute the same server VAAM data 20 as the first to third service servers 600A to 600C to the terminal 800.

The mirror processing section 730 includes in the form of programs: a management data updater 731; a subscription requestor 732 (subscription information requestor); a storing state determiner 733 (also works as the request subscription information acquirer); a mirror subscription editor 734 (subscription information updater); a mirror CDDL selector 735; a mirror content selector 736 (distribution controller); and a mirror download recognizer 737 (alternative end-of-distribution recognizer).

When the server VAAM data 20 is newly saved in at least one of the first to third service servers 600A to 600C or updated, the management data updater 731 acquires this server VAAM data 20 via the network 200 to save in the mirror content storage section 720.

When having recognized that the server VAAM data 20 is updated by the management data updater 731, the subscription requestor 732 specifies the terminal 800 for distributing the updated advertising content 24 based on the terminal ID information 21 of the updated server VAAM data 20. Then, when having recognized that the subscription requestor 732 is connected to the specified terminal 800 via the network 200, the subscription requestor 732 transmits to the terminal 800 the subscription request information requesting to transmit the subscription metadata 10.

The storing state determiner 733 acquires the subscription metadata 10 returned in response to the subscription request information, and recognizes, based on the object-defining information 11A, one or more of the first to third service servers 600A to 600C that distribute the advertising content 24 to be subscribed. Further, the storing state determiner 733 determines whether or not the advertising content 24 to be subscribed is stored in the mirror content storage section 720 based on the ID of the terminal 800 recorded in the communication-related information 11D and the ID of the terminal ID information 21 stored in the mirror content storage section 720.

For instance, when having acquired the subscription metadata 10 as shown in FIG.

2, the storing state determiner 733 recognizes that the first and second service servers 600A and 600B distribute the advertising contents 24 and determines whether or not these advertising contents 24 to be subscribed are stored.

Then, when the storing state determiner 733 determines that the advertising content 24 to be subscribed is stored, the storing state determiner 733 outputs the stored information to the mirror subscription editor 734. On the other hand, when having determined that the advertising content 24 to be subscribed is not stored, the storing state determiner 733 creates a non-stored information to transmit to the terminal 800 via the network 200.

When having acquired the stored information from the storing state determiner 733, the mirror subscription editor 734 edits the subscription metadata 10 received from the terminal 800.

Specifically, the mirror subscription editor 734 records a URL “ . . . local.server” of the mirror server 700 as the distributor's URL and creates the communication-related information 11D in which an ID “mirror” of this mirror server 700 is recorded. Then, the mirror subscription editor 734 inserts this communication-related information 11D in the subscription information 11 that corresponds to the to-be-subscribed advertising content 24 stored in the mirror content storage section 720. Further, a distributor's attribute information 11C of the subscription information 11 into which the communication-related information 11D is inserted is updated from “vaam server=‘default’” to “vaam server=‘mirror’”. In other words, a record that the distributer is changed from the default service server section 600 to the mirror server 700 is made in the distributor's attribute information 11C.

For instance, when the mirror subscription editor 734 acquires the stored information indicating that the advertising content 24 of the second service server 600B is stored, as shown in FIG. 12, the mirror subscription editor 734 edits the subscription metadata 10 as shown in FIG. 2 by inserting a new communication-related information 11D in the subscription information 11 of the second service and updating the distributor's attribute information 11C.

Then, the mirror subscription editor 734 transmits this edited subscription metadata 10 to the terminal 800.

When having acquired the download finish information by the mirror download recognizer 737, i.e., when all the advertising contents 24 have been downloaded, the mirror subscription editor 734 deletes the communication-related information 11D inserted in the edited subscription metadata 10. Further, the mirror subscription editor 734 records that the distributor has been changed from the mirror server 700 to the default service server section 600 in the distributor's attribute information 11C, and transmits the information to the terminal 800. In other words, the mirror subscription editor 734 transmits the unedited subscription metadata 10 to the terminal 800.

The mirror CDDL selector 735 and the mirror content selector 736 conduct processes similar to those of the server CDDL selector 432A and the server content selector 433A of the first service server 600A.

In other words, when the mirror CDDL selector 735 and the mirror content selector 736 respectively acquire the VAAM protocol starting information and the distribution request information, the mirror CDDL selector 735 and the mirror content selector 736 search and acquire the respectively corresponding CDDL metadata 22 and the advertising content 24 from the mirror content storage section 720 to transmit to the terminal 800.

When having acquired the download finish information from the terminal 800, the mirror download recognizer 737 records that the advertising content 24 has been downloaded in the download status information 23 of the mirror content storage section 720. Further, via the network 200, when having recognized that the first to third service servers 600A to 600C including the downloaded advertising content 24, the mirror download recognizer 737 transfers the download finish information to the connected first to third service servers 600A to 600C.

As shown in FIG. 8, the terminal 800 has an arrangement that differs from the first embodiment only in the terminal processing section 860.

The terminal processing section 860 has an arrangement different from the first embodiment in the terminal subscription editor 861 (which also works as the subscription information acquirer and the subscription information transmitter) and the subscribed service distribution device specifier 862 (subscribed device specifier).

When having acquired the subscription request information from the mirror server 700, the terminal subscription editor 861 transmits the subscription metadata 10 of the memory 520 to the mirror server 700. In addition, when having acquired the subscription metadata 10 from the mirror server 700, the terminal subscription editor 861 edits the subscription metadata 10 of the memory 520 to be the same as the subscription metadata 10 from the mirror server 700.

The subscribed service distribution device specifier 862 searches the subscription information 11 whose object-defining information 11A includes a record that this subscription information 11 involves the to-be-subscribed object and determines whether or not the distributor recorded in the distributor's attribute information 11C of the searched subscription information 11 is a default one. Then, when having determined that the distributor is a default one, the subscribed service distribution device specifier 862 specifies the first to third service servers 600A to 600C as subscribed service distribution devices. On the other hand, when having determined that the distributor is not a default one, the subscribed service distribution device specifier 862 specifies the mirror server 700 as a subscribed service distribution device.

Incidentally, when the mirror server 700 is specified as the subscribed service distribution device, the distributed content recognizer 563, the distribution requestor 565, the terminal save controller 566, and the end notifier 567 conduct processes similar to those of the first embodiment with the mirror server 700.

Operation of Advertisement Distribution System

Next, as an example of operation of the advertisement distribution system 100B, a distribution process of an advertising content will be described with reference to the drawings.

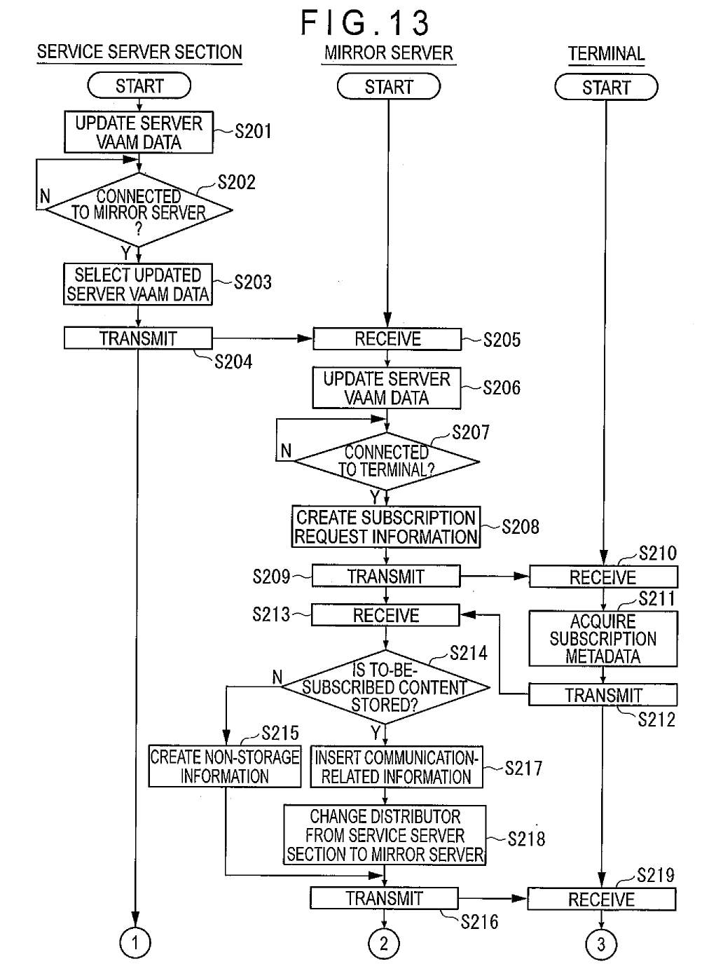

FIGS. 13, 14, and 15 are flowcharts showing a distribution process of the advertising content.

Incidentally, the processes similar to those in the first embodiment will be denoted with like numerals and description thereof will be omitted or simplified.

Initially, as shown in FIG. 13, when having updated the server VAAM data 20 (Step S201), the first to third service servers 600A to 600C of the service server section 600 determine whether or not the first to third service servers 600A to 600C are connected to the mirror server 700 (Step S202).

When having determined that the first to third service servers 600A to 600C are not connected thereto in Step S202, the first to third service servers 600A to 600C conduct the process of Step S202 after lapse of a predetermined time, for instance. On the other hand, when having determined that the first to third service servers 600A to 600C are connected thereto, the first to third service servers 600A to 600C select the updated server VAAM data 20 (Step S203) to transmit to the mirror server 700 (Step S204).

When having received the server VAAM data 20 (Step S205), the mirror server 700 saves the server VAAM data 20 in the mirror content storage section 720 (Step S206) so that the mirror content storage section 720 stores the same server VAAM data 20 as the service server section 600. Then, the mirror server 700 determines whether or not the mirror server 700 is connected to a terminal 800 that corresponds to this saved server VAAM data 20 (Step S207).

When having determined that the mirror server 700 is not connected thereto in Step S207, the mirror server 700 conducts the process of Step S207 after lapse of a predetermined time. On the other hand, when having determined that the mirror server 700 is connected thereto, the mirror server 700 creates a subscription request information (Step 5208) to transmit to the terminal 800 (Step S209).

When having received the subscription request information (Step S210), the terminal 800 acquires subscription metadata 10 of the memory 520 (Step S211) to transmit to the mirror server 700 (Step S212).

For instance, when having received the subscription metadata 10 as exemplarily shown in FIG. 2 (Step S 213), the mirror server 700 determines whether or not the advertising content 24 to be subscribed is stored in the mirror content storage section 720 based on this subscription metadata 10 (Step S214).

When having determined that the advertising content 24 to be subscribed is not stored therein in Step S214, the mirror server 700 creates an unstored information (Step S215) to transmit to the terminal 800 (Step S216). On the other hand, when having determined that the advertising content 24 to be subscribed is stored therein in Step S214, the mirror server 700 creates a communication-related information 11D regarding the mirror server 700 to insert in the subscription information 11 (Step S217). Further, the mirror server 700 changes the distributor indicated by the distributor's attribute information 11C to the mirror server 700 from the service server section 600 (Step S218), and transmits the subscription metadata 10 as exemplarily shown in FIG. 12 to the terminal 800. In short, the mirror server 700 conducts the process of Step S216.

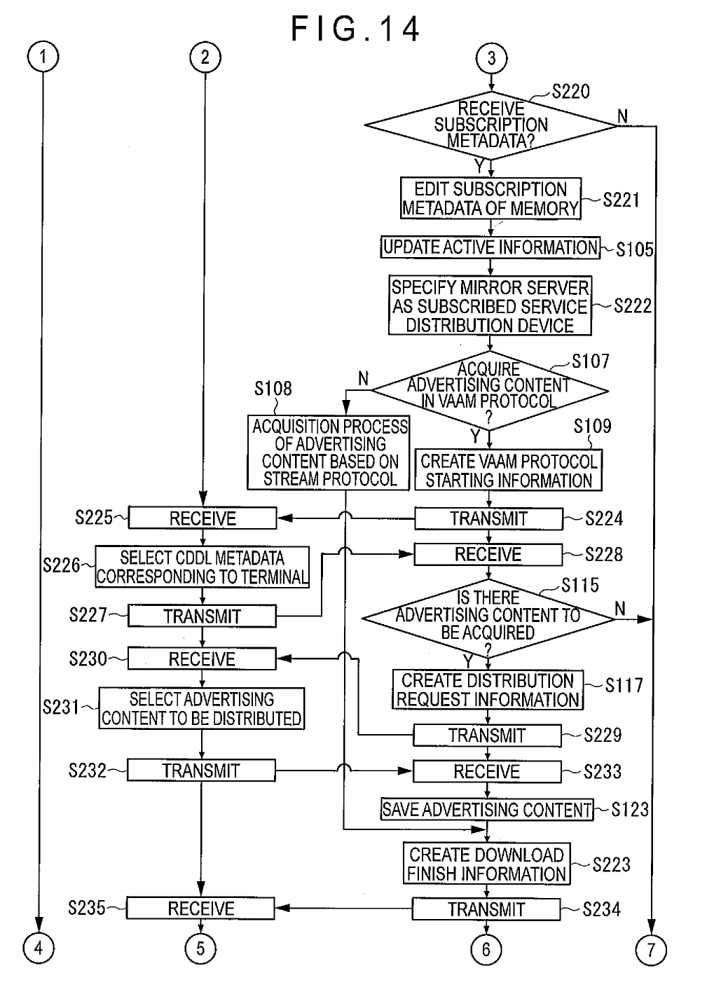

When having received the unstored information or the subscription metadata 10 from the mirror server 700 (Step S219), as shown in FIG. 14, the terminal 800 determines whether or not the terminal 800 has received the subscription metadata 10 (Step S220).

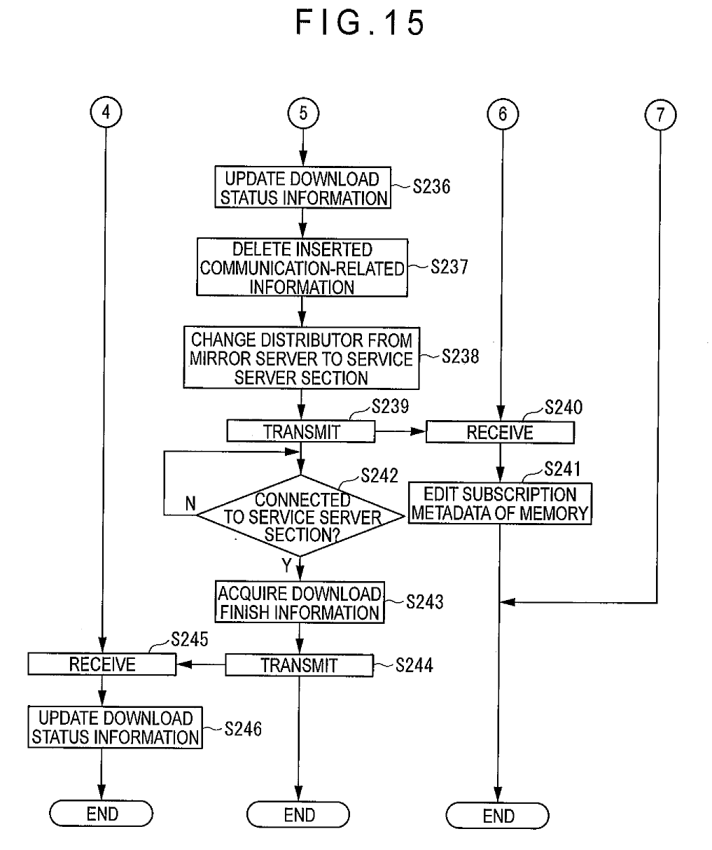

When having determined that the terminal 800 has received the unstored information in Step S220, as shown in FIG. 15, the terminal 800 ends the process. On the other hand, when having determined that the terminal 800 has received the subscription metadata 10 in Step S220, as shown in FIG. 14, the terminal 800 edits the subscription metadata 10 of the memory 520 based on this received subscription metadata 10 (Step 5221) and conducts the process of Step S105. Subsequently, the terminal 800 specifies the mirror server 700 as the subscribed service distribution device (Step S222) and conducts the process of Step S107.

When having determined to acquire the advertising content 34 in the stream protocol in Step S107, the terminal 800 conducts the process of Step S108 and creates the download finish information (Step S223). On the other hand, when having determined to acquire the advertising content 24 in the VAAM protocol in Step S107, the terminal 800 conducts the process of Step S109 and transmits the VAAM protocol starting information to the mirror server 700 (Step S224).

When having received the VAAM protocol starting information (Step S225), the mirror server 700 selects the CDDL metadata 22 that corresponds to the terminal 800 from the mirror content storage section 720 (Step S226) to transmit to the terminal 800 (Step S227).

When having received the CDDL metadata 22 (Step S228), the terminal 800 conducts the process of Step S115. Then, when having determined that the advertising content 24 to be acquired does not exist in Step S115, the terminal 800 ends the process as shown in FIG. 15. On the other hand, when having determined that the advertising content 24 to be acquired exists in Step S115, the terminal 800 conducts the process of Step S117 to transmit the distribution request information to the mirror server 700 (Step S229).

When having received the distribution request information (Step S230), the mirror server 700 selects the advertising content 24 to be subscribed (Step S231) to transmit to the terminal 800 (Step S232).

When having received the advertising content 24 in Step S233, the terminal 800 conducts the process of Step S123 and conducts a process for creating the download finish information, i.e., the process of Step S223. Then, the terminal 800 transmits the download finish information to the mirror server 700 (Step S234).

When having received the download finish information (Step S235), as shown in FIG. 15, the mirror server 700 updates the download status information 23 of the mirror content storage section 720 (Step S236). Subsequently, the mirror server 700 deletes the inserted communication-related information 11D from the edited subscription metadata 10 (Step S237), and changes the distributor indicated by the distributor's attribute information 11C to the service server section 600 from the mirror server 700 (Step S238). In other words, the mirror server 700 returns the subscription metadata 10 to a status before the editing. Then, the mirror server 700 transmits this subscription metadata 10 to the terminal 800 (Step S239).

When having received the subscription metadata 10 that has been returned to the status before the editing (Step S240), the terminal 800 edits the subscription metadata 10 of the memory 520 (Step S241) and ends the process.

When having conducted the process of Step 239, the mirror server 700 determines whether or not the mirror server 700 is connected to the service server section 600 including the downloaded advertising content 24 (Step S242). When having determined that the mirror server 700 is not connected to such a service server section 600 in Step 242, the mirror server 700 conducts the process of Step S242 after lapse of a predetermined time. On the other hand, when having determined that the mirror server 700 is connected to such a service server section 600 in Step 242, the mirror server 700 acquires the download finish information received from the terminal 800 (Step S243) to transmit to the connected service server section 600 (Step S244).

When one or more of the first to third service servers 600A to 600C of the service server section 600 that have the downloaded advertising content 24 receive the download finish information (Step S245), such one or more of the first to third service servers 600A to 600C update the download status information 23 (Step S246) and end the process.

### Advantages of Second Embodiment

As described above, in the second embodiment, the following advantages are attained in addition to the advantages similar to those of the first embodiment.

Specifically, the mirror server 700 includes the mirror content storage section 720 that stores the same advertising content 24 as the first to third service servers 600A to 600C. In addition, the mirror server 700 transmits the subscription request information to the terminal 800 to acquire the subscription metadata 10 from the terminal 800. Then, when having recognized that the advertising content 24 to be subscribed is stored in the mirror content storage section 720 based on this subscription metadata 10, the mirror server 700 edits the subscription metadata 10 so that the mirror server 700 is specified as the subscribed service distribution device to transmit to the terminal 800. Subsequently, the mirror server 700 distributes the advertising content 24 to be subscribed to the terminal 800 based on the distribution request information transmitted from the terminal 800.

With the above arrangement, the advertisement distribution system 100B can suitably distribute the same advertising content 24 as the service server section 600 to the terminal 800. Accordingly, even when the number of the terminals 800 increases, increase in the number of access to the service server section 600 can be restrained, thereby reducing the processing burden of the service server section 600. In addition, speedy distribution of the advertising content 24 can be achieved. Further, even in an environment where, e.g., connection with the service server section 600 is impossible, the terminal 800 can acquire the advertising content 24 from the mirror server 700.

When the mirror server 700 acquires the download finish information from the terminal 800, the mirror server 700 transmits the subscription metadata 10 that has been returned into the status before the editing to the terminal 800. Subsequently, the terminal 800 edits the subscription metadata 10 of the memory 520 so that the subscription metadata 10 is returned into a status before the editing, i.e., so that the service server section 600 is specified as the subscribed service distribution device.

With this arrangement, the terminal 800 can return the setting of the subscribed service distribution device to the default service server section 600 after acquiring the advertising content 24 from the mirror server 700, so that the terminal 800 can acquire the advertising content 24 from the service server section 600 without contradictory communication.

Further, when the mirror server 700 recognizes that the mirror server 700 is connected to the service server section 600, the mirror server 700 transfers to the service server section 600 the download finish information acquired from the terminal 800.

With this arrangement, the service server section 600 can recognize that service server section 600 has distributed the advertising content 24 adapted for distribution to the terminal 800 via the mirror server 700, thereby achieving appropriate management of distribution status.

### Modifications of Embodiments

Incidentally, the scope of the invention is not limited to the above-described first and second embodiments, but includes the following modifications as long as an object of the invention can be achieved.

Specifically, in the first and second embodiments, the subscription metadata 10 may be arranged to record that advertising contents distributed in a plurality of protocols are to be subscribed.

With this arrangement, the terminal 500, 800 can acquire based on one subscription metadata 10 the advertising content 24, 34 based on the VAAM protocol and the stream protocol, thereby improving efficiency of the acquisition process of the advertising content 24, 34.

In addition, in the second embodiment, an arrangement in which the subscription metadata 10 before the editing is not transmitted to the terminal 800 at the time when the mirror server 700 receives the download finish information from the terminal 800 may be employed.

With this arrangement, the processing burden of the mirror server 700 can be reduced.

Further, in the second embodiment, an arrangement in which the mirror server 700 does not transfer the download finish information to the service server section 600 may be employed.

With this arrangement, the processing burden of the mirror server 700 can be further reduced.

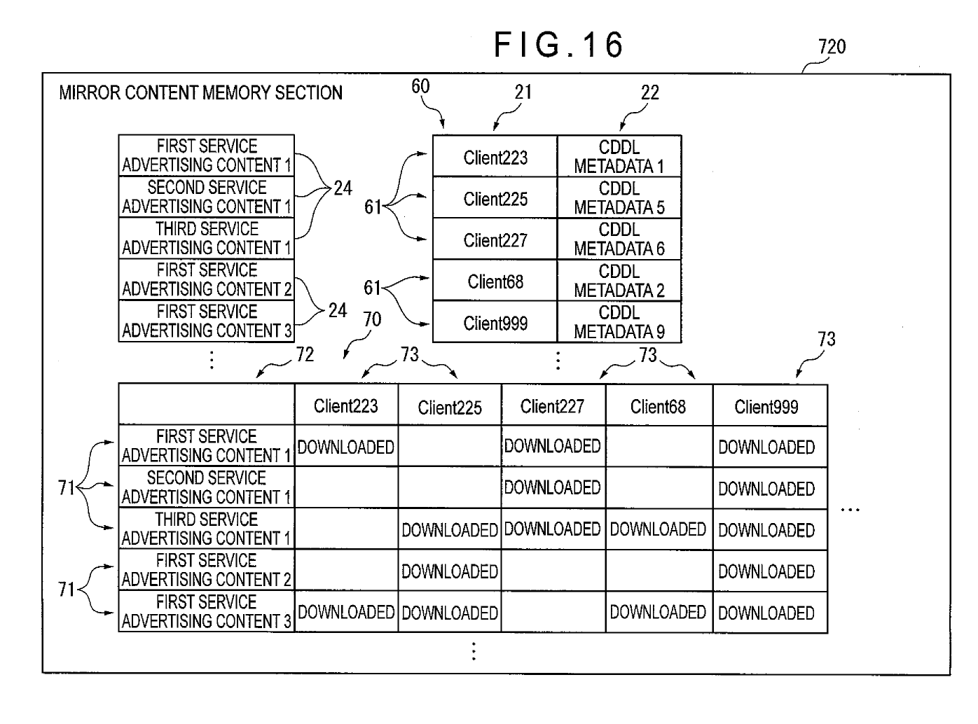

In addition, in the second embodiment, as shown in FIG. 16, the mirror content storage section 720 may be arranged to store various data.

Specifically, the mirror content storage section 720 stores the advertising content 24, the CDDL management database 60, and the download management data 70.

The CDDL management database 60 includes at least one terminal CDDL management data 61. The terminal CDDL management data 61 has a data structure in which the terminal ID information 21 and the CDDL metadata 22 are associated.

Here, “Client 999” represents the ID of the mirror server 700. In other words, the CDDL management database 60 includes the terminal CDDL management data 61 that corresponds to the mirror server 700 itself.

The download management data 70 includes at least one classified-by-content download status information 71. This classified-by-content download status information 71 has a data structure in which the content-identifying information 72 for identifying the advertising content 24 and the classified-by-terminal status information 73 for showing the download status for each terminal 800 are associated. This classified-by-content download status information 71 exemplarily indicates that the advertising content 24 of “first service advertising content 1” is downloaded by the terminals 800 of “Client 223” and “Client 227” and the mirror server of “Client 999” but is not downloaded by the terminals 800 of “Client 225 and “Client 68”. In other words, the download management data 70 includes the download status information 71 that manages the download status of the advertising content 24 of the mirror server 700 itself

Incidentally, an arrangement in which various data to be stored in the server storage sections 420A, 420B, 420C, and 420D of the first embodiment are stored in a status similar to the arrangement shown in FIG. 16 and managed may be employed.

In addition, content to be distributed may include a television program, a movie, and music. Further, the protocol at the time of communication may be a protocol other than the VAAM protocol and the stream protocol.

In addition, although the functions are constructed in the form of programs in the above description, the functions may be arranged in a hardware such as a circuit board, in an element such as an IC (integrated circuit), or in any other suitable manner. Incidentally, when an arrangement in which a program or suitable recording media is read out is employed, handling can be facilitated in the above arrangements, thereby achieving a wide utilization of the technique.

Other than what has been described, specific structure and procedure at the time of implementation of the invention may be suitably changed to other structures or the like as long as an object of the invention can be achieved.

### Advantages of Embodiments

As described above, in the above embodiments, the terminal 500 acquires the subscription metadata 10 respectively defined for each of the first to fourth service servers 400A to 400D regarding whether or not the first to fourth service servers 400A to 400D distribute the advertising content 24, 34 to be subscribed. Then, a server that distributes the advertising content 24, 34 to be subscribed is specified as the subscribed service distribution device from among the first to fourth service servers 400A to 400D. Subsequently, the terminal 500 recognizes the difference between the advertising content 24, 34 adapted for distribution by the subscribed service distribution device and the already acquired advertising content 24, 34, and transmits the distribution request information to the subscribed service distribution device to acquire the advertising content 24, 34.

Accordingly, the terminal 500 can acquire the advertising content 24, 34 from at least one of the first to fourth service servers 400A to 400D based on the subscription metadata 10. In other words, service given to the terminal 500 can be easily switched by using the subscription metadata 10.

With this arrangement, unification of specifications of the first to fourth service servers is not necessary, so that lowering of the service and competitiveness of the first to fourth service servers 400A to 400D can be restrained, and occurrence of new cost can be restrained.

Thus, the terminal 500 can acquire a favorable advertising content 24, 34 with a simple arrangement.

Further, the advertisement distribution system 100A is formed by: the first to fourth service servers 400A to 400D for distributing the advertising content 24, 34 based on the distribution request information; the terminal 500; and the like.

Thus, a favorable advertising content 24, 34 can be distributed and acquired in a simple arrangement according to the advertisement distribution system 100A.

### INDUSTRIAL APPLICABILITY

The present invention can be implemented in a content acquisition processing device, a content distribution system, a content acquisition processing method, and a program thereof, in which a content distributed by a content distribution device based on a content requesting information that requests distribution of a predetermined content is acquired.

1. A content distribution system, comprising:
a plurality of content distribution devices that distribute a content based on a distribution request information that requests distribution of a predetermined content;
a content acquisition processing device that is connected to the plurality of content distribution devices and acquires, via a network, a content distributed by the content distribution
device based on the distribution request information; and
an alternative distribution device connected to the content acquisition processing device via the network and capable of distributing to the content acquisition processing device a content adapted for distribution by the plurality of content distribution devices, wherein
the alternative distribution device includes:
a content storage that stores the content;
a subscription information requestor that transmits to the content acquisition processing device a subscription transmittance request information that requests transmittance of a subscription information regarding whether or not the content distribution device distributes the content to be subscribed, the subscription information being defined for each content distribution device, the subscription information having been acquired by the content distribution device;
a request subscription information acquirer that acquires the subscription information transmitted in response to the subscription transmittance request information;
a storing state determiner that determines whether or not the content adapted for distribution by the content distribution device defined by the subscription information having been acquired is stored in the content storage;
a subscription information updater that, when the storing state determiner determines that the content adapted for distribution is stored, transmits to the content acquisition processing device the subscription information updated so that the alternative distribution device is defined as the content distribution device that distributes the content to be subscribed; and
a distribution controller that distributes the content to the content acquisition processing device in response to the distribution request information transmitted from the content acquisition processing device,
the content acquisition processing device includes:
a subscription information transmitter that, when having acquired the subscription transmittance request information from the alternative distribution device, transmits the subscription information,
a subscription information acquirer that acquires from the alternative distribution device the subscription information having been updated;
a subscribed device specifier that specifies the content distribution device as a subscribed distribution device based on the subscription information having been updated;
a difference recognizer that recognizes a difference between the content adapted for distribution by the alternative distribution device and the content having been acquired in advance; and
a distribution requestor that transmits to the alternative distribution device the distribution request information that requests distribution of the content corresponding to the difference between the content adapted for distribution by the alternative distribution device and the content having been acquired in advance.

2. The content distribution system according to claim 1, wherein
the content distribution device distributes the content based on a predetermined communication protocol, and
the subscription information includes a record defining that the content distribution device based on the one communication protocol distributes the content to be subscribed and defining that the content distribution device based on a communication protocol other than the one communication protocol does not distribute the content to be subscribed.

3. (canceled)

4. (canceled)

5. The content distribution system according to claim 1, wherein
the content acquisition processing device further includes end notifier that transmits, when having acquired the content in response to the distribution request information from the alternative distribution device, an end-of-acquisition information to the alternative distribution device,
the alternative distribution device includes an end-of-alternative-distribution recognizer that acquires the end-of-acquisition information transmitted from the content acquisition processing device and that recognizes that the content has been acquired by the content acquisition processing device, and
the subscription information updater of the subscription distribution device transmits the subscription information before updating to the content acquisition processing device when having recognized that the end-of-acquisition information has been acquired.

6. The content distribution system according to claim 5, wherein
when having acquired the end-of-acquisition information, the end-of-alternative-distribution recognizer of the alternative distribution device transmits the end-of-acquisition information to the content distribution device adapted for distribution of the contents having been distributed to the content acquisition processing device, and
the content distribution device includes an end-of-distribution recognizer that acquires the end-of-acquisition information transmitted from the alternative distribution device and recognizes that the content adapted for distribution by the content distribution device is acquired by the content acquisition processing device.

7. A content distribution method for distributing a content, the method comprising:
using a plurality of content distribution devices that distribute a content based on a distribution request information that requests distribution of a predetermined content, a content acquisition processing device that is connected to the plurality of content distribution devices and acquires, via a network, a content distributed by the content distribution device based on the distribution request information, and an alternative distribution device connected to the content acquisition processing device via the network and capable of distributing to the content acquisition processing device a content adapted for distribution by the plurality of content distribution devices, wherein
the alternative distribution device
transmits to the content acquisition processing device a subscription transmittance request information that requests transmittance of a subscription information regarding whether or not the content distribution device distributes the content to be subscribed, the subscription information being defined for each content distribution device,
acquires the subscription information transmitted in response to the subscription transmittance request information,
determines whether or not the content adapted for distribution by the content distribution device defined by the subscription information having been acquired is stored in the content storage,
when the storing state determiner determines that the content adapted for distribution is stored, transmits to the content acquisition processing device the subscription information updated so that the alternative distribution device is defined as the content distribution device that distributes the content to be subscribed, and
distributes the content to the content acquisition processing device in response to the distribution request information transmitted from the content distribution processing device, and
the content acquisition processing device
transmits the subscription information when having the subscription transmittance request information from the alternative distribution device, wherein the alternative distribution device
transmits to the content acquisition processing device a subscription transmittance request information that requests transmittance of a subscription information regarding whether or not the content distribution device distributes the content to be subscribed, the subscription information being defined for each content distribution device,
acquires the subscription information transmitted in response to the subscription transmittance request information,
determines whether or not the content adapted for distribution by the content distribution device defined by the subscription information having been acquired is stored in the content storage,
when the storing state determiner determines that the content adapted for distribution is stored, transmits to the content acquisition processing device the subscription information updated so that the alternative distribution device is defined as the content distribution device that distributes the content to be subscribed, and
distributes the content to the content acquisition processing device in response to the distribution request information transmitted from the content distribution processing device, and
the content acquisition processing device
transmits the subscription information when having acquired the subscription transmittance request information from the alternative distribution device,
acquires from the alternative distribution device the subscription information having been updated,
specifies alternative distribution device as a subscribed distribution device based on the subscription information having been updated,
recognizes a difference between the content adapted for distribution and having been updated and the content having been acquired in advance, and
transmits the distribution request information that requests distribution of the content corresponding to the difference between the content updated for distribution by the alternative distribution device and the content having been acquired in advance to the alternative distribution device.

8. A content distribution program that instructs a computer to execute the content distribution method according to claim 7.

9. The content distribution system according to claim 2, wherein
the content acquisition processing device further includes end notifier that transmits, when having acquired the content in response to the distribution request information from the alternative distribution device, an end-of-acquisition information to the alternative distribution device,
the alternative distribution device includes an end-of-alternative-distribution recognizer that acquires the end-of-acquisition information transmitted from the content acquisition processing device and that recognizes that the content has been acquired by the content acquisition processing device, and
the subscription information updater of the subscription distribution device transmits the subscription information before updating to the content acquisition processing device when having recognized that the end-of-acquisition information has been acquired.
